(19) United States
(12) Patent Application Publication
(10) Pub. No.: US 2013/0018670 A1
(43) Pub. Date: Jan. 17, 2013

(54) SYSTEM AND METHOD FOR ANALYZING PATIENT DATA

(71) Applicants: David Charles Pankratz, Austin, TX (US); Paul Eugene Markwardt, Verona, WI (US); Todd David Weston, Verona, WI (US)

(72) Inventors: David Charles Pankratz, Austin, TX (US); Paul Eugene Markwardt, Verona, WI (US); Todd David Weston, Verona, WI (US)

(73) Assignee: General Electric Company, Schenectady, NY (US)

(21) Appl. No.: 13/180,061

(22) Filed: Jul. 11, 2011

(51) Int. Cl. G06Q 50/00

(52) U.S. Cl. 705/3

(57) ABSTRACT

A system includes a host computer system that includes a processor configured to acquire and to analyze image data acquired from a medical imaging device. The system also includes a pluggable support configured to couple to the host computer system, wherein the pluggable support comprises an executable analysis program configured to automatically access the one or more databases via the host computer system, the one or more databases storing data summarizing the image data, and to analyze individual patient data from multiple patients within at least one database of the one or more databases.

### BACKGROUND OF THE INVENTION

The subject matter disclosed herein relates to imaging systems and more particularly to a system for analyzing data acquired from imaging systems.

A number of medical imaging systems of various designs are known and are presently in use. Examples of medical imaging systems include basic X-ray systems, computed tomography systems, positron emission tomography systems, magnetic resonance imaging systems, fluoroscopy systems, duel-energy X-ray absorptiometry systems, and ultrasound imaging systems. Through the use of medical imaging systems, medical professionals, such as physicians, can produce detailed images of internal tissues, anatomies and organs of patients, thereby mitigating the need for invasive exploratory procedures and providing valuable tools for identifying and diagnosing disease and for verifying wellness.

The data acquired from the imaging systems may be stored in one or more databases in data storage systems for later analysis. Health care providers and other parties, such as representatives of pharmaceutical companies, may find information gathered from the data within the databases useful. For example, this information may be valuable to a health care provider in order to determine the effectiveness of a specific treatment on the current patient base. Also, this information may help facilitate a discussion between, for example, pharmaceutical representatives and the health care provider to determine the treatment options that work best for patients. In addition, the information allows the health care provider to follow up with specific patients for whom modification in treatment may be of value.

However, specific challenges arise when large amounts of medical-related data are made available on systems cataloging and storing such data. For example, these data storage systems may be difficult and time consuming to navigate to gather the sought after information. In addition, attempts to navigate these storage systems may not gather all of the desired and relevant information that may be useful in analyzing the current patient base. Also, certain information within these databases such as patient identifying information needs to be available only for those individuals with permission to view such information.

There is a need, therefore, for improved approaches to minimize the time necessary to search the data within these databases. There is a particular need for a technique that can collect the relevant data quickly and present the data in a meaningful and useful manner while protecting patient identifying information from unauthorized viewing.

### BRIEF DESCRIPTION OF THE INVENTION

In accordance with one embodiment, a system includes a host computer system that includes a processor configured to acquire and to analyze image data acquired from a medical imaging device. The system also includes a pluggable support configured to couple to the host computer system, wherein the pluggable support comprises an executable analysis program configured to automatically access the one or more databases via the host computer system, the one or more databases storing data summarizing the image data, and to analyze individual patient data from multiple patients within at least one database of the one or more databases.

In accordance with another embodiment, a system includes a pluggable support configured to couple to a host computer system. The pluggable support includes an executable analysis program. The executable analysis program is configured to automatically access one or more databases via the host computer system, to analyze individual patient data from multiple patients within at least one database of the one or more databases, and to not store data from the at least one database and the host computer system on the pluggable support.

In accordance with a further embodiment, a method for analyzing patient data stored on a database includes coupling a pluggable support to a host computer system. The pluggable support includes an executable analysis program that automatically accesses one or more databases via the host computer system, each database of the one or more databases stores individual patient data from multiple patients, and the executable analysis program does not store individual patient data on the pluggable support. The method also includes selecting at least one database from the one or more databases. The method further includes selecting a report type for summarizing analyzed individual patient data from the at least one database. The method yet further includes generating a report summarizing the individual patient data from the multiple patients from the at least one database analyzed by the executable analysis program.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic view of an exemplary system for analyzing data, equipped in accordance with aspects of the present technique;

FIG. 2 is a diagrammatical overview of data within a database, in accordance with aspects of the present technique;

FIG. 3 is a flow diagram of an exemplary method for analyzing data stored within a database, in accordance with aspects of the present technique;

FIG. 4 is an example of a screen for selecting a database to analyze;

FIG. 5 is an example of a screen for selecting a report type for presenting the analyzed data;

FIG. 6 is an example of a screen for selecting one or more physicians to query the database;

FIG. 7 is an example of a screen for selecting a level of detail for a report of the analyzed data;

FIG. 8 is an example of a screen for selecting which patients from the database to include in the report; and

FIG. 9 is an example of a report of the analyzed data.

### DETAILED DESCRIPTION OF THE INVENTION

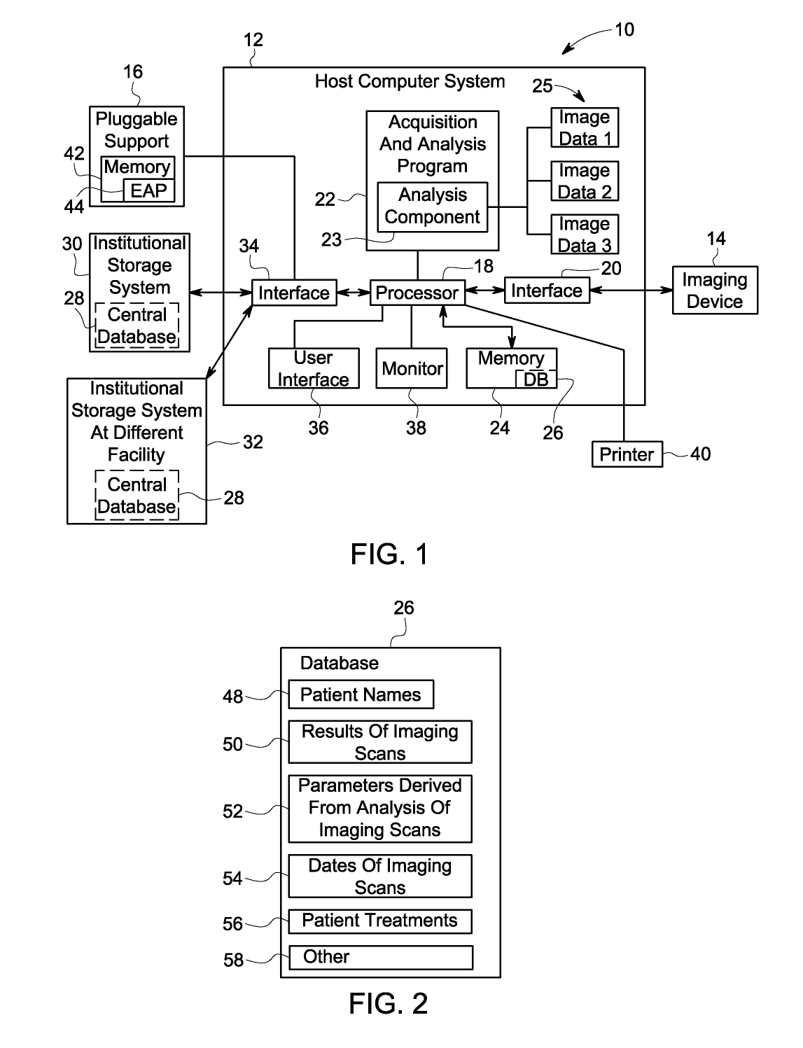

Referring generally to FIG. 1, a system for analyzing data is represented generally by reference numeral 10. In certain embodiments, the analyzed data may include individual patient data gathered from multiple patients. In the embodiment illustrated in FIG. 1, the system 10 includes a host computer system 12, an imaging device 14 communicatively coupled to the host computer system 12, and a pluggable support 16 coupled to the host computer system 12. As discussed in greater detail below, the host computer system 12 is configured to facilitate access to one or more databases storing data (e.g., patient data) for analysis by a program stored on the pluggable support 16. Although the techniques discussed below are discussed in the context of a medical setting and patient data, these techniques may be employed to analyze any type of data stored within databases.

The host computer system 12 includes a processor 18. The processor 18 is configured to acquire and to analyze image data acquired from the imaging device 14. The processor 18 receives image data from the imaging device 14 via interface 20. The imaging device 14 may include a medical imaging device such as a computed tomography imaging device, a positron emission tomography device, a magnetic resonance imaging device, a fluoroscopy imaging device, an ultrasound imaging device, an X-ray imaging device, or dual-energy X-ray absorptiometry device. In certain embodiments, the processor 18 may include circuitry to command operation of the imaging system to execute examination protocols. The processor 18 includes a program 22 such as an acquisition and analysis program (e.g., enCORE™ software platform) configured to acquire and analyze image data (e.g., imaging scans) received from the imaging device 14. In certain embodiments, the processor 18 may acquire and analyze image data generated by other devices 14 via an institutional network. The program 22 may be stored within a memory 24 of the host computer system 12. The acquisition and analysis program 22 includes an analysis component 23 that receives image data 25 (e.g., image data 1, image data 2, and image data 3) and analyzes the image data 25 to generate results and parameters derived form the data 25. As illustrated, image data 1, image data 2, and image data 3 each represent image data 25 acquired from multiple patients. Alternatively, the image data 1, image data 2, and image data 3 may represent separate image data 25 acquired from the same patient.

The processor 18 stores data generated by the program 22 from the acquired image data 25 in a database 26. In certain embodiments, the database 26 may be stored within the memory 24 on the host computer system 10. In other embodiments, the database 26 may be stored within a central database 28 within an institutional storage system 30 remote from the host computer system 12 but located within the same facility as the system 12. Alternatively, the central database 28 may be located within an institutional storage system 32 at a facility different from the location of the host computer system 12. The host computer 12 may serve as a server to store or retrieve data from one or more databases 26 within the central database 28 via interface 34 with the institutional storage systems 30 and 32. The institutional storage systems 30 and 32 may include a radiology information system (RIS), a hospital information system (HIS), and/or picture archiving communication system (PACS).

The processor 18 is also linked to a user interface 36, monitor 38, and a printer 40. The user interface 36 may include a mouse, a keyboard, or any other device for receiving user input to operate programs on the host computer system 14 and the pluggable support 16. The monitor 38 enables visualization of image data (e.g., images), user interface screens for using the programs on the system 14 and the pluggable support 16, reports generated by the data analysis program on the pluggable support 16, and so forth. The printer 40 enables the printing of the report generated by the program on the pluggable support 16.

As mentioned above, the pluggable support 16 includes a program to analyze data (e.g., individual patient data) from multiple patients stored within one or more databases 26. The pluggable support 16 may include any tangible, non-transitory computer-readable medium for storing code to analyze the data stored within one or more databases 26. For example, the pluggable support 16 may include a flash memory card, an USB flash card, an USB flash drive, or a flash drive with non-USB interface. The pluggable support 16 includes a memory 42 (e.g., flash memory) storing an executable analysis program 44 that includes code configured to enable the program 44 to analyze the data within one or more databases 26. The pluggable support 16 includes a mechanism to track each time the support 16 is used. For example, the executable analysis program 44 may be configured to track each usage of the pluggable support 16. The number of uses for each pluggable support 16 may be limited by the number of licenses granted for the use of the executable analysis program 44 on each support 16. Once the limit for the number of uses for the program 44 is reached, the executable analysis program 44 may no longer be used on the pluggable support 16.

Turning now to the function of the executable analysis program 44, the program 44 is configured to automatically access the one or more databases 26 via the host computer system and to analyze individual patient data from multiple patients stored within at least one database of the one or more databases 26. As mentioned above, the accessed databases 26 may be stored within the memory 24 of the host computer system 12. Alternatively, the host computer system 12 may act as a server to access the databases 26 from the central database 28 within the institutional storage systems 30 and 32. The executable analysis program 44 interacts with the database 26. The executable analysis program 44 is configured to analyze individual patient data from multiple patients within a selected database 26 and to generate a report summarizing the individual patient data within the database 26. Alternatively, the executable analysis program 44 may be used to analyze individual patient data for a single patient. In particular, the executable analysis program 44 includes database reading and reporting logic (e.g., ADO.NET technology) to read and analyze the data within the database 26.

Depending on who generates the report, patient identifying information (e.g., patient names) may not be available. For example, if a physician or other person allowed to lawfully access patient identifying information uses the executable analysis program 44 to generate the report, the program 44 is configured to identify individual patients. However, if a third party (e.g., pharmaceutical representative) with the physician's permission uses the executable analysis program 44 to generate the report, the program 44 can be configured to not identify individual patients. For example, the report hides the names of the individual patients. To further protect patient information, the executable analysis program 44 is configured to not store data acquired from the selected database 26 on the pluggable support 16. In addition, the executable analysis program 44 can be configured to not store analyzed data generated from the selected database 26 on the pluggable support 16. Further, the executable analysis program 44 is configured to not install programs on the host computer system 12. Yet further, the executable analysis program 44 is configured to not modify stored programs on the host computer system 12 and data within the databases 26.

Upon coupling the pluggable support 16 to the host computer system, the executable analysis program 44 is configured to access all of the databases 26 as described above. Upon accessing the databases 26, the executable analysis program 44 enables a user to select a database 26 from among the databases 26 for analysis. In certain embodiments, the user may select more than one database 26 form among databases for analysis. The executable analysis program 44 is further configured to enable the user to select a report type for summarizing the analyzed individual patient data from the selected database 26 as described in greater detail below. In addition, the executable analysis program 44 is configured to enable the user to query the selected database 26 by one or more physicians. Further, the executable analysis program 44 is configured to enable the user to specify a level of detail for the report. The level of detail in the report determines whether or not the report includes patient identifying data (e.g., patient names). At a first level of detail (e.g., if the report will be viewed by a third party without lawful access to patient identifying information), the report summarizes the individual patient information within the database and hides the names of individual patients. At a second level of detail, the report provides more detailed individual patient information and shows the names of the individual patients. Also, the executable analysis program 44 is configured to enable the user to limit the number of patients queried in the selected database 26 as described in greater detail below. Upon customizing the report, the executable analysis program 44 is configured to automatically generate the report summarizing individual patient data from multiple patients from the selected database 26. For example, the program 44 may generate the report using ComponentOne® Suite and TxControl™ technology. As mentioned above, the selected detail level of the report determines if the report includes or does not include patient identifying information. The user may print the generated report via the printer 40 coupled to the host computer system 12. The executable analysis program 44 provides the user a quick and efficient technique to summarize data of interest within the selected database 26. The generated report may provide the health care provider a summary of how the current patient base is responding to a specific treatment. Besides providing a summary of the current patient base, the report may provide the health care provider a summary for individual patients to allow the provider to determine if any modifications of the treatment may be of use for a particular patient. The report may also identify patients who are due for specific medical scans (e.g., a bone mineral density scan). In addition, the generated report may help facilitate discussions between pharmaceutical representatives and health care providers based on the summarized data without disclosing patient identifying information.

FIG. 2 illustrates the data (e.g., patient data) within the databases 26 above that may be analyzed by the executable analysis program 44 and presented in the generated report. For example, the data may include patient names 48. As mentioned above, the level of detail in the generated report determines if the patient names 48 will be present in the report. In addition, the data may include results of imaging scans 50 acquired from the medical imaging devices 14 above. The data may also include parameters derived from analysis of the imaging scans 52. For example, the parameters may include a score for bone mineral density. The data may also include dates of imaging scans 54 and patient treatments 56 (e.g., specific drugs taken by a patient or procedures performed on a patient). The dates 54 may be used to identify those patients who have not been scanned within a given time period (e.g., two years). Further, the databases 26 may include other data 58 (e.g., physicians, patient age, patient sex, patient height, patient weight, etc.).

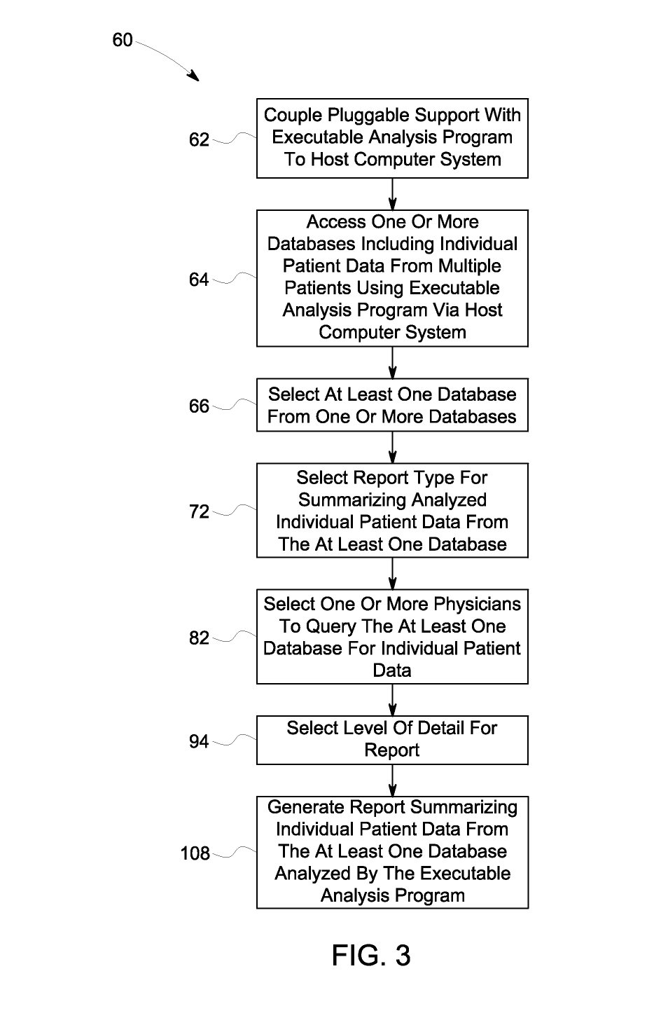

FIG. 3 illustrates a flow diagram of an exemplary method 60 for analyzing data stored within the selected database 26. The method 60 includes coupling the pluggable support 16 with the executable analysis program 44 stored thereon to the host computer system 12 (block 62). Upon coupling the pluggable support to the system 12 (block 62), the executable analysis program 44 automatically accesses the one or more databases 26 via the host computer system 12 (block 64) as described above. Each database 26 includes individual patient data for multiple patients. As mentioned above, the executable analysis program 44 does not store the individual patient data and the analyzed individual patient data on the pluggable support 16. Also, the program 44 does not modify the data within the databases 26.

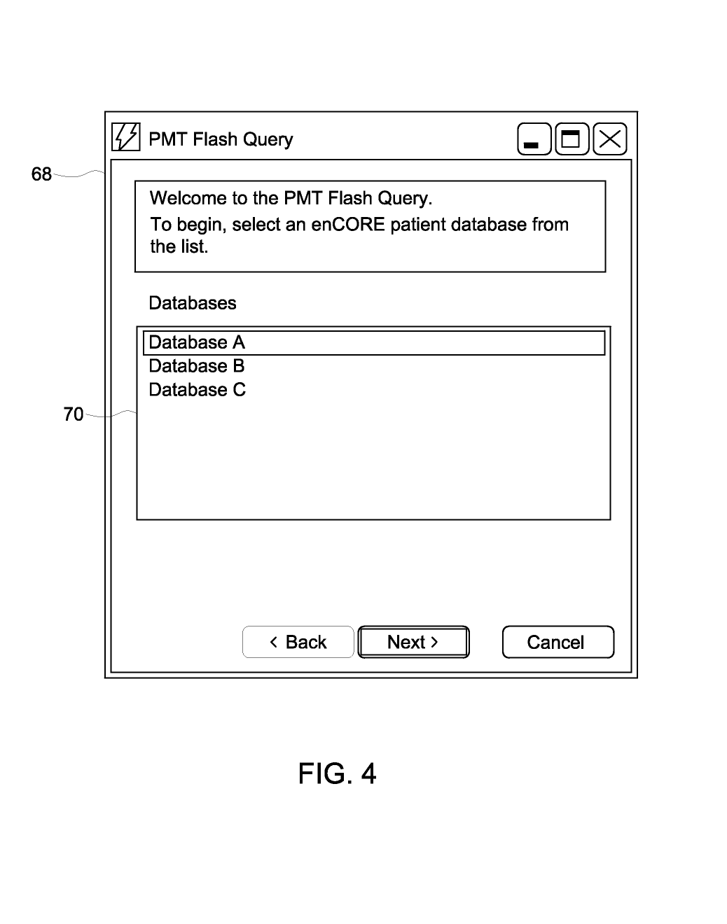

After accessing the databases 26 (block 64), the method 60 includes selecting at least one database 26 from the databases 26 (block 66) via a user interface screen 68 generated by the executable analysis program 44. FIG. 4 illustrates an example of the user-viewable screen 68. The user-viewable screen 68 provides a list 70 of databases 26 to choose from. The program 44 enables the user to select a single database 26 from among the listed databases 26. In certain embodiments, the user may be allowed to select more than one database 26. For example, as illustrated in FIG. 4, database A is selected from among databases A, B, and C.

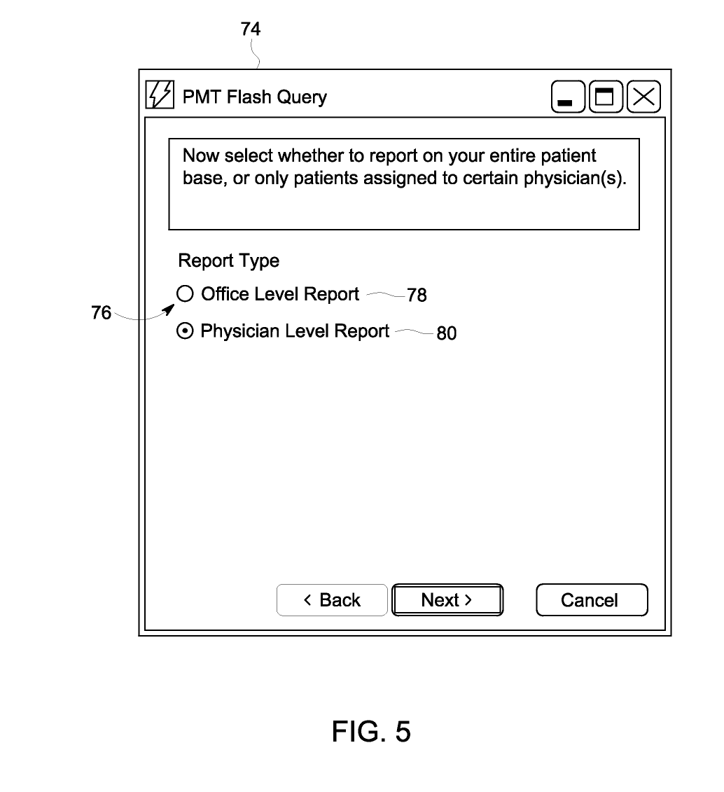

After selecting the database 26 (block 66), the method 60 includes selecting a report type for summarizing analyzed individual patient data from the selected database 26 (block 72) via a user-viewable screen 74 generated by the executable analysis program 44. FIG. 5 illustrates an example of the user-viewable screen 74. As illustrated, the user-viewable screen 74 provides an option 76 for selecting between an office level report 78 and a physician level report 80. The office level report 78 enables the program 44 to summarize the individual patient data from all of the patients scanned by a particular imaging device 14. The physician level report 80 enables the program 44 to summarize the individual patient data from all of the patients assigned to a particular physician.

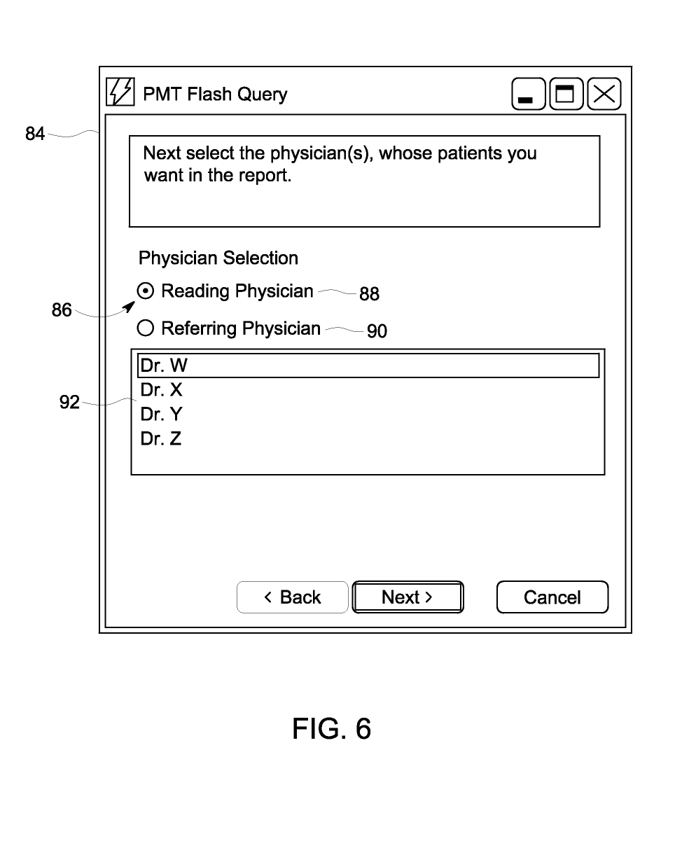

If the physician level report 80 is selected, the method 60 includes selecting one or more physicians to query the selected database 26 (block 82) via a user-viewable screen 84 generated by the executable analysis program 44. A single physician or multiple physicians may be selected to collect the individual patient data from the multiple patients of the selected physicians. FIG. 6 illustrates an example of the user-viewable screen 84. As illustrated, the user-viewable screen 84 provides an option 86 for selecting between a reading physician 88 and a referring physician 90. The user-viewable screen 84 provides a list 92 of physicians (e.g., of reading physicians or referring physicians) for the selected physician type. The program 44 enables the user to select one or more physicians from among the listed physicians. For example, as illustrated in FIG. 6, Dr. W is selected from among Drs. W, X, Y, and Z.

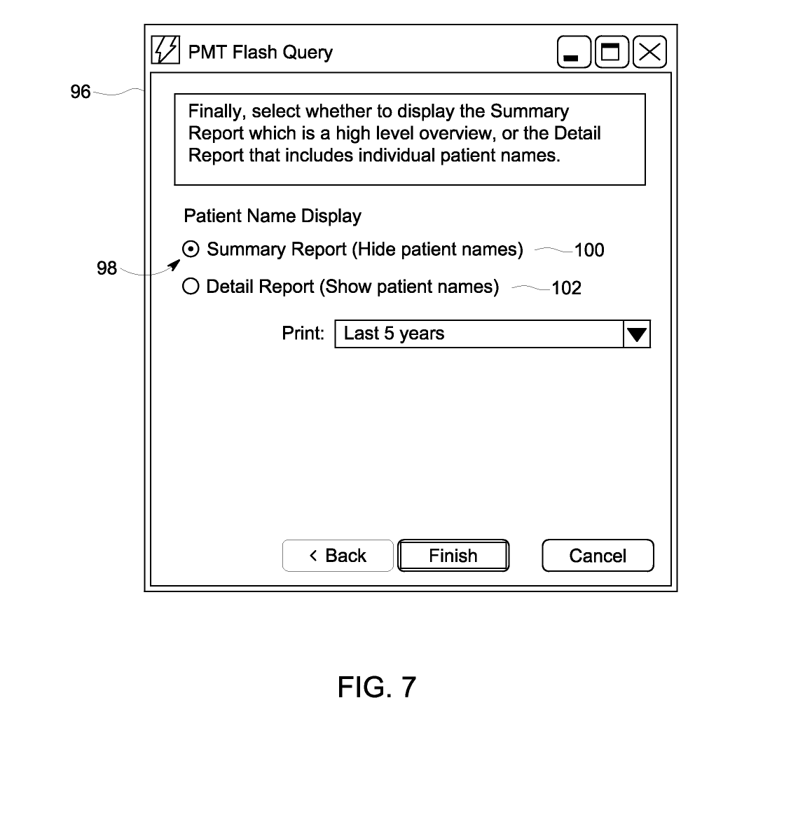

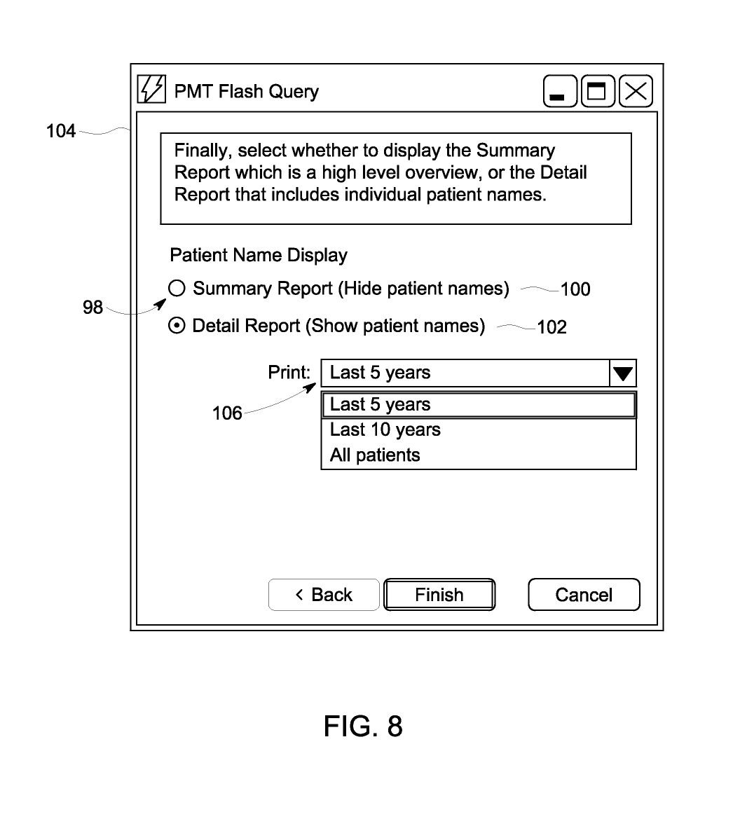

Subsequent to selecting the report type (block 72), the method 60 includes selecting a level of detail for the report (block 94) via a user-viewable screen 96 generated by the executable analysis program 44. As mentioned above, the level of detail in the report determines whether or not the report includes patient identifying data (e.g., patient names). FIG. 7 illustrates an example of the user-viewable screen 96. As illustrated, the user-viewable screen 96 provides an option 98 for selecting between a summary report 100 and a detail report 102. The summary report 100 represents a first level of detail (e.g., if the report will be viewed by a third party without lawful access to patient identifying information). The summary report 100 summarizes the individual patient information within the selected database 26 and hides the names of individual patients in the report to be generated. The detail report 102 represents a second level of detail (e.g., for physicians eyes only). The detail report 102 provides more detailed individual patient information and shows the names of the individual patients. If the user selects the detail report 102, the program 44 enables the user to limit the number of patients queried. FIG. 8 illustrates an example of a user-viewable screen 104 with the detail report 102 selected. Upon selecting the detail report 102, the user-viewable screen 104 provides a list 106 of options to narrow the number of patients queried. For example, the number of patients may be limited to the patients within the last 5 years or the patients within the last 10 years. Alternatively, the list 106 may allow the user to select all of the patients meeting the other user-specified criteria (e.g., report type, physicians, etc.).

After selecting the level of detail for the report (block 94), the method 60 includes generating a report summarizing the individual patient data from the multiple patients from the selected database 26 analyzed by the executable analysis program 44 (block 108). The generated report is based on the analysis of the individual patient data from the multiple patients in accordance with the user-specified criteria described above. The generated report may be printed on the printer 40 coupled to the host computer system 12 or accessible through a network.

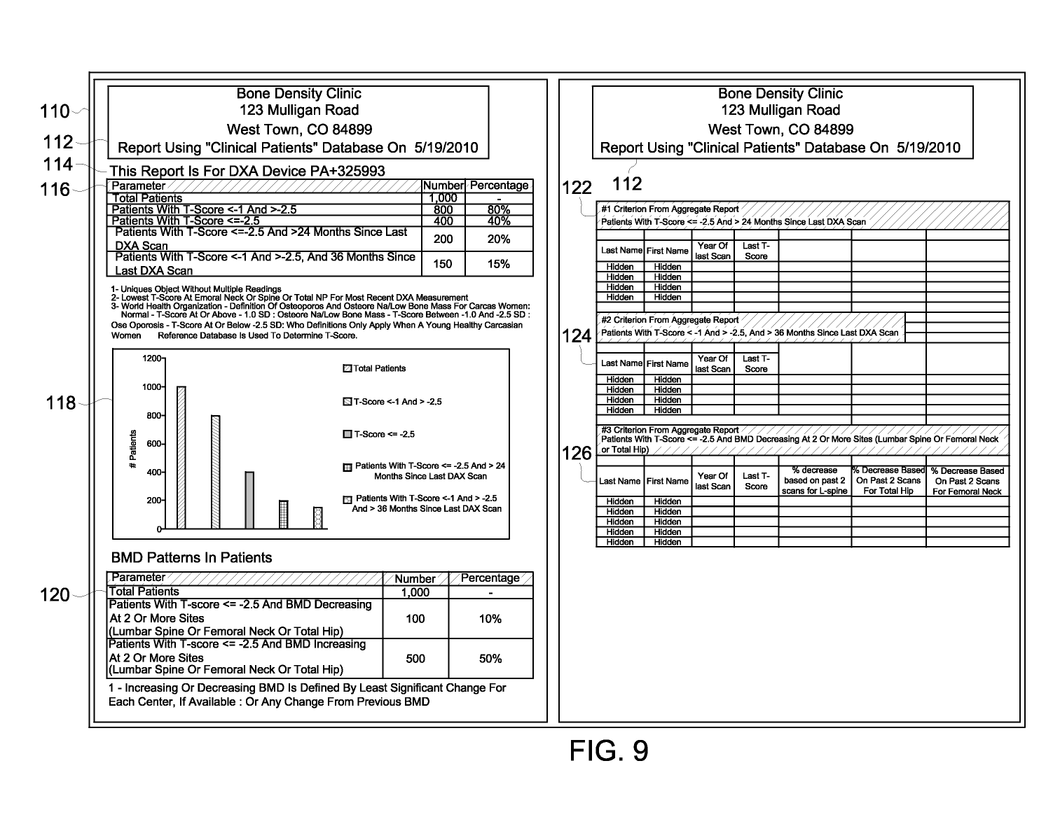

FIG. 9 illustrates an example of a generated report 110. The following items included in the report 110 are intended to represent only a few examples of items to include. Additional items of interest to the user may be included in the report 110. The report 110 includes a header 112. The header 112 may include information related to the facility or institution (e.g., facility or institutional name, facility or institutional address, etc.), the selected database 26 used to generate the report 110, and/or a date when the report 110 was generated. The report 110 also includes the imaging device 14 (e.g., medical imaging device) from which the selected database 26 was generated as represented by numeral 114. In addition, the report 110 includes parameters or criteria 116 used to analyze the patient data. For example, the parameters 116 may include a total number of patients from which patient data was analyzed. The parameters 116 may also include criteria (e.g., bone mineral density scores and/or time since last imaging scan) to sort patients. The report 110 includes a number of patients and/or a percentage of patients that fall within each of the sorting criteria. Further, the report 110 illustrates the parameters 116 and associated patient data in a graph 118 (e.g., bar graph, pie graph, etc.). In addition to the graph 118, the report 110 includes patterns 120 and parameters or criteria associated with the patterns 120. For example, the pattern 120 may represent bone mineral density patterns in the analyzed patients. The parameters associated with the patterns 120 may include the total number of patients from which patient data was analyzed, results of imaging scans (e.g., bone mineral density scores), and status of a physiological condition at a certain number of specific sites within the bodies of the patients (e.g., increasing or decreasing bone mineral density at a certain number of sites within the bodies of the patients). The patterns 120 may include the number of patients and the percentage of the analyzed patients that meet the parameters or criteria associated with the patterns. In certain embodiments, the report 110 may also include patient treatments and/or changes in the physiological condition of the analyzed patients in response to the patient treatments. The report 110 also lists data for individual patients that fall within the various search criteria. For example, individual patients may be listed based on the date of their last scan and/or last bone-mineral density score as represented by numerals 122 and 124. In addition, individual patients may be listed based on the date of their last scan, last bone mineral density score, and/or the percentage changes in bone mineral density in specific sites of the body as represented by numeral 126. As mentioned above, generated reports 110, specified as summary reports 100, hide the names of the patients as illustrated in listings 122, 124, and 126 of the patients. Generated reports 110, specified as detail reports 102, show the names of the patients, for example, in listings 122, 124, and 126.

Technical effects of the embodiments include providing methods and systems to analyze patient data in a quick and efficient manner and to present the analyzed patient data in a user-friendly manner. Specifically, the pluggable support 16 is plugged into the host computer system 22 to access one or more databases 26 via the host computer system 22. The pluggable support 16 includes the executable analysis program 44 that interacts with the host computer system 12 to enable the user to select a database 26 of individual patient data for multiple patients and to customize the query and the type of report for the data to be analyzed within the database 26. The program 44 does not modify the analyzed data. In addition, the program 44 does not store acquired data on the pluggable support 16. Further, the program 44 does not install programs on the host computer system 14. The report generated by the program 44 may allow the user (e.g., health care provider) to identify patterns in the current patient base, for example, in response to various treatments. In addition, the report may facilitate a discussion between the health care provider and a third party (e.g., pharmaceutical representative) without identifying individual patients.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a host computer system comprising a processor configured to access and to analyze image data acquired from a medical imaging device; and
a pluggable support configured to couple to the host computer system, wherein the pluggable support comprises an executable analysis program configured to automatically access one or more databases via the host computer system, the one or more databases storing data summarizing the image data, and to analyze individual patient data from multiple patients stored within at least one database of the one or more databases.

2. The system of claim 1, the system comprising the medical imaging device coupled to the host computer system.

3. The system of claim 2, wherein the medical imaging device comprises a computed tomography imaging device, a positron emission tomography device, a magnetic resonance imaging device, a fluoroscopy imaging device, an ultrasound imaging device, an X-ray imaging device, or dual-energy X-ray absorptiometry device.

4. The system of claim 1, wherein the one or more databases are stored on the host computer system.

5. The system of claim 1, wherein the one or more databases are stored on a central database remote from the host computer system.

6. The system of claim 1, wherein the patient data includes results of imaging scans, parameters derived from analysis of the imaging scans, individual patient names, patient treatments, or dates of the imaging scans.

7. The system of claim 1, wherein the pluggable support comprises a USB flash drive.

8. The system of claim 1, wherein the executable analysis program is configured to analyze the individual patient data but not to identify individual patients.

9. The system of claim 1, wherein the executable analysis program is configured to analyze the individual patient data and to identify individual patients.

10. The system of claim 1, wherein the executable analysis program is configured to not store both the data acquired from the at least one database and analyzed data generated from the at least one database on the pluggable support.

11. The system of claim 1, wherein the executable analysis program is configured not to install programs on the host computer system and not to modify stored programs on the host computer system and data within the at least one database.

12. The system of claim 1, wherein the executable analysis program is configured to enable a user to select the at least one database from the one or more databases and to enable a user to select a report type for summarizing the analyzed individual patient data from the at least one database.

13. The system of claim 12, wherein the executable analysis program is configured to generate a report summarizing the individual patient data from the at least one database.

14. The system of claim 13, wherein the report does not include patient identifying information.

15. The system of claim 13, wherein the report does include patient identifying information.

16. The system of claim 1, wherein the executable analysis program is configured to track each time the pluggable support is used.

17. A system comprising:
a pluggable support configured to couple to a host computer system and comprising an executable analysis program configured to automatically access one or more databases via the host computer system, to analyze individual patient data from multiple patients stored within at least one database of the one or more databases, and to not store data from the at least one database and the host computer system on the pluggable support.

18. The system of claim 17, wherein the executable analysis program is configured to analyze the individual patient data but not identify individual patients.

19. The system of claim 17, wherein the executable analysis program is configured to analyze the individual patient data and to identify individual patients.

20. The system of claim 17, wherein the executable analysis program is configured to not install programs on the host computer system and to not modify stored programs on the host computer system and the individual patient data within the at least one database.

21. The system of claim 17, wherein the executable analysis program is configured to enable a user to select the at least one database from among the one or more databases and to enable a user to select a report type to summarize the analyzed individual patient data from the at least one database.

22. The system of claim 17, wherein the executable analysis program is configured to generate a report summarizing the individual patient data from the at least one database.

23. A method for analyzing patient data stored within a database, comprising:
coupling a pluggable support to a host computer system, wherein the pluggable support comprises an executable analysis program that automatically accesses one or more databases via the host computer system, each database of the one or more databases stores individual patient data from multiple patients, and the executable analysis program does not store the individual patient data on the pluggable support;
selecting at least one database from the one or more databases;
selecting a report type for summarizing analyzed individual patient data from the at least one database; and
generating a report summarizing the individual patient data from multiple patients from the at least one database analyzed by the executable analysis program.

24. The method of claim 23, comprising selecting one or more physicians to query the at least one database for the individual patient data.

25. The method of claim 23, comprising selecting a level of detail for the report, wherein a first level of detail hides names of individual patients and a second level of detail shows the names of the individual patients.
